(19) United States
(12) Patent Application Publication
(10) Pub. No.: US 2004/0179316 A1
(43) Pub. Date: Sep. 16, 2004

(54) Post heat dissipation device for preventing heat accumulation of power supply and computer system after the computer is shut off

(76) Inventor: Tsung Yen Tsai, Taipei Hsien (TW)

Correspondence Address: Tsung Yen Tsai, 235 Chung - Ho, Box 8-24, Taipei Hsien, TW

(21) Appl. No.: 10/805,628

(22) Filed: Mar. 22, 2004

(30) Foreign Application Priority Data
Oct. 28, 1992 (TW) 092219133

(51) Int. Cl. H02H 5/04

(52) U.S. Cl. 361/103

(57) ABSTRACT

A post heat dissipation device serves for preventing heat accumulation of a power supply and a computer system after the computer is shut off. The post heat dissipation device comprises a power supply for supplying power; a fan control circuit; a delay switching circuit connected to the fan control circuit; a fan set including power supply fans, and system fan set through the delay switching circuit and the fan control circuit for dissipating heat from the power supply and computer system. After the computer is shut down, the delay switching circuit is triggered to actuate a standby power which is then transferred to the fan set so that the fan set rotates with a lower speed than those in normal operations.

### FIELD OF THE INVENTION

The present invention relates to heat dissipating devices of computers, and particular to a post heat dissipation device for preventing heat accumulation of a power supply and a computer system after the computer is shut off.

### BACKGSEMI-ROUND OF THE INVENTION

With the advance of integrated circuit (IC), a CPU is made more and more compact and has a higher speed than old ones. Thereby, a great deal of heat is generated. For example, currently, the working temperatures of Pentium series CPUs are about 60° C. and those of AMD K7s are about 80° C. Moreover, the power supply must provide more power to the system. However in current trend, it is desired that the electronic devices have compact size, that is, they are smaller, and thus, it is required that the heat dissipating devices of those devices are compact with a powerful heat dissipating ability. As a result, the amount of electronic elements for voltage reduction and rectifying, such as transformers, rectifiers, etc. is increased.

To have higher heat dissipation capacity, more and more fans are used in a computer. However, when the computer is shut off, the fans are stopped, while since the rectifiers and transformers work in high temperature, the heats of these elements cannot be dissipated immediately and thus are accumulated. Finally, the heat will be transferred into the IC chips of the system so as to damage the IC chips as the device is used for a longer time period. And thus, the lifetime of the computer is shortened.

### SUMMARY OF THE INVENTION

Accordingly, the primary object of the present invention is to provide a post heat dissipation device for preventing heat accumulation of a power supply and a computer system after the computer is shut off. The post heat dissipation device comprises a power supply for supplying power; a fan control circuit; a delay switching circuit connected to the fan control circuit; a fan set including power supply fans and system fan set having power flowing through the delay switching circuit and the fan control circuit for dissipating heat from the power supply and computer system. After the computer is shut down, the delay switching circuit is triggered to actuate a standby power which is then transferred to the fan set so that the fan set rotates with a lower speed than normal operations.

The various objects and advantages of the present invention will be more readily understood from the following detailed description when read in conjunction with the appended drawing.

### BRIEF DESCRIPTION OF THE DRAWINGS

FIG. 1 is a circuit block diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

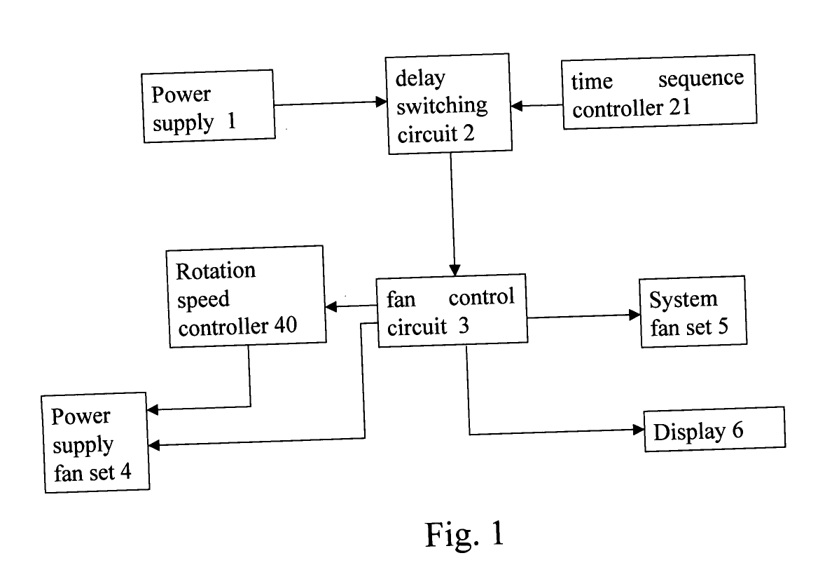

With reference to FIG. 1, the post heat dissipation device for preventing heat accumulation of a power supply and a computer system after the computer is shut off of the present invention is illustrated. The device comprises the following elements.

A power supply 1 supplies power of a voltage of 12V.

A delay switching circuit 2 is connected to a fan control circuit 3.

A time sequence controller 21 serves for setting a delay time of the delay switching circuit 2 manually.

A fan set includes power supply fans 4, and system fan set 5. Power is supplied from the power supply 1 through the delay switching circuit 2 and the fan control circuit 3 for dissipating heat from the power supply and computer system. In the present invention, the fan set includes at least one fan for dissipating heat generated from the integrated circuits in a motherboard, at least one fan for dissipating heat generated from VGA display chips; and at least one fan for a hard disk.

A rotation speed control circuit 40 is connected the fan control circuit 3 and the fans 4 of the power supply 1 for controlling the rotary speed of the power supply fans 4 by using a heat sensitive resistor 41 in the power supply 1 to sense the temperature of the power supply 1 and then transfer the temperature values to the rotation speed control circuit 40. Thereby, the objects of protecting the power supply 1 and reducing noises are achieved.

A display 6 is connected to the fan control circuit 3.

After the computer is shut down, the delay switching circuit 2 is triggered to actuate a +5V standby power which is then transferred to the fans 4 and 5 so that the fans 4 and 5 rotates with lower speeds than that of normal operations. The power supplied from the delay switching circuit 2 is actuated in a time period set by the time sequence controller 21. Meanwhile the display 6 displays the work state of the delay switching circuit 2.

Thereby, by above mentioned structure, when the computer is shut off, the fans 4, 5 will operate through a time period by using the delay switching circuit 2 so as to dissipate heat of the power supply 1 and the computer system. Thereby, heat accumulation of the ICs, rectifiers, and transformers, etc. due to the interruption of a computer can be dissipated by the present invention. Thereby, no heat is returned to other components of the computer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A post heat dissipation device for preventing heat accumulation of a power supply and a computer system after the computer is shut off, the post heat dissipation device comprising:
a power supply for supplying power;
a fan control circuit;
a delay switching circuit connected to the fan control circuit;
a fan set including power supply fan set and system fan set; power from the power supply flowing through the delay switching circuit and the fan control circuit for dissipating heat from the power supply and computer system;
wherein after the computer is shut down, the delay switching circuit is triggered to actuate a standby power which is then transferred to the fan set so that the fan set rotates with a lower speed than rotation speeds in normal operations.

2. The post heat dissipation device for preventing heat accumulation of a power supply and a computer system after the computer is shut off as claimed in claim 1, wherein the fan set includes at least one fan for the integrated circuits in a mother board, at least one fan for VGA display chips; and at least one fan for a hard disk.

3. The post heat dissipation device for preventing heat accumulation of a power supply and a computer system after the computer is shut off as claimed in claim 1, wherein the power supplied from the delay switching circuit is actuated in a time period set by an external time sequence controller,

4. The post heat dissipation device for preventing heat accumulation of a power supply and a computer system after the computer is shut off as claimed in claim 1, wherein a rotation speed control circuit is connected the fan control circuit and the fans of the power supply for controlling the rotary speed of the power supply fans by using a heat sensitive resistor in the power supply; the heat sensitive resistor senses the temperature of the power supply and then transfers the temperature values to the rotation speed control circuit so as to control the rotary speed of the power supply.

5. The post heat dissipation device for preventing heat accumulation of a power supply and a computer system after the computer is shut off as claimed in claim 1, wherein a display is connected to the fan control circuit for displaying actions of the delay switching circuit.
